(19) United States
(12) Patent Application Publication
(10) Pub. No.: US 2022/0013993 A1
(43) Pub. Date: Jan. 13, 2022

(54) APPARATUSES AND PROCESSES FOR PREPARING A SUPPRESSOR SEAL OF A SPARK PLUG INSULATOR ASSEMBLY

(71) Applicant: FRAM GROUP IP, LLC, Cleveland, OH (US)

(72) Inventors: Corey Eiden, Walbridge, OH (US); Jing Zheng, Findlay, OH (US)

(21) Appl. No.: 17/371,024

(22) Filed: Jul. 8, 2021

Related U.S. Application Data
(60) Provisional application No. 63/049,829, filed on Jul. 9, 2020.

(51) Int. Cl. H01T 21/02; H05B 6/10

(52) U.S. Cl. CPC H01T 21/02; B25J 11/00; H05B 6/105

(57) ABSTRACT

The present disclosure provides, inter alia, apparatuses for preparing a suppressor seal of a spark plug insulator assembly, and processes for fabricating and/or assembling a spark plug insulator assembly using the same. Also provided are automated systems for fabricating and/or assembling a spark plug insulator assembly, which includes an induction heating apparatus disclosed herein and other components such as, e.g., an auxiliary unit and a control unit, to automate and accelerate the manufacturing process.

### CROSS REFERENCE TO RELATED APPLICATIONS

The present application claims benefit of U.S. Provisional Patent Application Ser. No. 63/049,829, filed on Jul. 9, 2020, which application is incorporated by reference herein in its entirety.

### FIELD OF DISCLOSURE

The present disclosure relates generally to the field of internal combustion engines, and in particular, to ignition systems utilized in such engines. More specifically, the present disclosure provides, inter alia, apparatuses for preparing a suppressor seal of a spark plug insulator assembly, and processes for fabricating and/or assembling a spark plug insulator assembly using the same.

### BACKGROUND OF THE DISCLOSURE

A spark plug (also known as a sparking plug) is a device for delivering electric current from an ignition system to an engine's combustion chamber in order to ignite the compressed fuel/air mixture within the chamber through an electric spark, while containing combustion pressure within the engine. To achieve consistent operation with no ignition miss, a spark plug is designed to ensure positive insulation between spark and cylinder head while also sealing the combustion chamber.

A spark plug includes a terminal stud, an insulator, a shell, a seal seat and electrodes. In a typical spark plug, a metal threaded shell is electrically isolated from a center electrode by a porcelain insulator. The center electrode, which may include a resistor, is connected by a heavily insulated wire to the output terminal of an ignition coil or magneto. The spark plug's metal shell is inserted (usually screwed) into the engine's cylinder head and thus electrically grounded. The center electrode at one end of the insulator protrudes into the combustion chamber, forming one or more spark gaps between the tip of the center electrode and one or more protuberances or structures attached to the inner end of the threaded shell (i.e., the ground (earth) electrode(s)).

Because the spark plug also seals the combustion chamber of the engine when installed, seals (both external and internal) are required to ensure there is no leakage from the combustion chamber. In particular, the internal seal (or suppressor seal) is created inside the spark plug insulator and may also connect the terminal stud and the center electrode. Currently, the preparation of a good suppressor seal inside the spark plug insulator involves a flame heating process, usually fueled by a fuel such as natural gas. Such a process suffers from various drawbacks. For example, given the expensive nature of natural gas (or other fuels), such a process is relatively costly. Such a process also lacks consistency given the variability in the heating effect. The finished product from such process often has relatively large range of suppressor resistance values, which can impair the efficiency of suppressing noise signals generated at the time of spark discharge. Such a process also may require process changes for different product models, such as, e.g., raising or lowering gas burner positions, changing supporting holders, increaings gas flow rate, changing gas air mixture ratio, etc.

Accordingly, there is a need for new and improved apparatuses and processes for creating a suppressor seal of a spark plug insulator assembly, which are energy-efficient, reliable, consistent and cost-effective.

### SUMMARY OF THE DISCLOSURE

The present disclosure provides improved apparatuses and processes used in producing spark plug insulators. In accordance with some embodiments, the disclosure provides an apparatus that allows heating non-thermally conductive materials with induction heat. Advantages of this technology include, inter alia, significant reductions in energy requirements compared to existing techniques that rely on fuels, e.g., natural gas, as well as improved heat control and efficiency with resultant tighter range in resistance values on the finished product.

According to certain embodiments of the present disclosure, an apparatus for preparing a suppressor seal of a spark plug insulator assembly comprises: (a) a protective housing for the spark plug insulator; (b) a crucible surrounding the housing; (c) an induction heating element placed nearby the outer surface of the crucible; (d) an induction power supply connected to the induction heating element; and (e) a stud press.

The present disclosure also includes a process for fabricating and/or assembling a spark plug insulator assembly according to certain embodiments. Such a process comprises the steps of: (a) filling a spark plug insulator with a seal material; (b) placing the spark plug insulator inside a protective housing; (c) activating an induction power supply and heating the spark plug insulator until an inside temperature of 850-900° C. is reached; (d) inserting an insertion into the spark plug insulator to construct a spark plug insulator assembly; (e) applying a stud press on top of the insertion and holding for approximately one minute; and (f) releasing the stud press and removing the spark plug insulator assembly from the protective housing.

The present disclosure also includes an automated system for fabricating and/or assembling a spark plug insulator assembly according to certain embodiments. Such a system comprises: (a) at least one apparatus configured to prepare a suppressor seal of a spark plug insulator assembly using induction heat; (b) one or more auxiliary units, the one or more auxiliary units being configured to perform the following operations: (i) filling the spark plug insulator with a seal material; (ii) placing a spark plug insulator on the apparatus; (iii) inserting an insertion into the spark plug insulator; (iv) applying and releasing a stud press; and (v) removing the spark plug insulator assembly from the apparatus; and (c) one or more computerized control units, the one or more computerized control units being configured to control operation of the at least one apparatus and the one or more auxiliary units.

### BRIEF DESCRIPTION OF THE DRAWINGS

To facilitate further description of the embodiments of this disclosure, the following drawings are provided to illustrate and not to limit the scope of the disclosure.

FIG. 1 illustrates a perspective view of an existing apparatus for creating a suppressor seal in a spark plug using natural gas burners.

FIG. 2 illustrates a perspective view of an apparatus using induction heating for creating a suppressor seal in a spark plug, in accordance with certain embodiments of the present disclosure.

FIG. 3 is an illustrative flow chart of an exemplary process for fabricating and/or assembling a spark plug insulator assembly, in accordance with certain embodiments of the present disclosure.

FIG. 4 is a table demonstrating that the induction heating process described herein can significantly reduce energy consumption and save cost.

FIG. 5 is a table demonstrating that a production line employing the induction heating process described in the present disclosure can further reduce the cost. FT\hat{ }3: cubic feet; GJ: gigajoule.

FIG. 6 is a table demonstrating a performance comparison between the gas heating process and the induction heating process described in the present disclosure. LVRi: seal resistance at 5 vdc, HVRi: seal resistance at 4500 vdc and; COV: covariance.

FIG. 7 is a block diagram illustrating an exemplary automated system for fabricating and/or assembling a spark plug insulator assembly with a suppressor seal according to certain embodiments.

### DETAILED DESCRIPTION OF THE DISCLOSURE

Novel apparatuses for preparing a suppressor seal of a spark plug insulator assembly and processes of producing spark plug insulator assemblies using such apparatuses are provided and described. Various embodiments and modifications are possible and fall within the scope of the present disclosure.

According to certain embodiments of the present disclosure, an apparatus for preparing a suppressor seal of a spark plug insulator assembly comprises: (a) a protective housing for the spark plug insulator; (b) a crucible surrounding the housing; (c) an induction heating element placed nearby the outer surface of the crucible; (d) an induction power supply connected to the induction heating element; and (e) a stud press.

In some embodiments, the protective housing can be selected to accommodate different spark plug insulators or the same spark plug insulator in different orientations. In some embodiments, the protective housing is thermally conductive.

As used herein, the term “crucible” can refer to a ceramic or metal container in which metals or other substances may be melted or subjected to very high temperatures. In the context of the present disclosure, a crucible can be used to transfer heat to the spark plug insulator, which is made or constructed of a material that cannot be directly heated by an induction heating element.

In some embodiments, the crucible is placed in close proximity of the protective housing to efficiently transfer heat. In some embodiments, the crucible is electrically conductive. In some embodiments, the crucible is made of metal or ceramic. In some embodiments, the crucible is made of a material selected from the group consisting of alumina, zircornia, magnesia, quartz, graphite, corundum, pyrolytic boron nitride (PBN), platinum, tungsten, molybdenum, tantalum, nickel, zirconium, silicon carbide, vitreous carbon. In some embodiments, the crucible is made of molybdenum disilicide (MoSi₂).

As used herein, “induction heating” can refer to the process of heating an electrically conducting object (e.g., a metal) by electromagnetic induction, through heat generated in the object by eddy currents. In the context of the present disclosure, an “induction heating element” can be the output head of an induction heater powered by an induction power supply.

In some embodiments, the induction heating element can be an induction heating coil winding around the crucible. In some embodiments, the induction heating element can radiantly heat the spark plug insulator up to an inside temperature of 850-900° C.

In some embodiments, the apparatus disclosed herein further comprises a spacer situated in between the crucible and the induction heating element. In some embodiments, the spacer is made of aluminum oxide (Al₂O₃). In the context of this disclosure, the spacer locates the cruiclbe and protective housing relative to the induction heating coil to constrain the location of these three objects and maintain consistent heating performance over time.

In some embodiments, the stud press can compress and hold an insertion within the spark plug insulator. In the context of the present disclosure, a “stud press” can refer to a tool that can apply pressure (through, e.g., its own weight) on the top of a part or assembly to be processed and hold a desired position for a period of time. In some embodiments, the stud press is automated, e.g., by pnumatic and spring force combined.

In some embodiments, the insertion is a terminal stud or a center electrode.

The present disclosure also includes a process for fabricating and/or assembling a spark plug insulator assembly according to certain embodiments. Such a process comprises the steps of: (a) filling a spark plug insulator with a seal material; (b) placing the spark plug insulator inside a protective housing; (c) activating an induction power supply and heating the spark plug insulator until an inside temperature of 850-900° C. is reached; (d) inserting an insertion into the spark plug insulator to construct a spark plug insulator assembly; (e) applying a stud press on top of the insertion and holding for approximately one minute; and (f) releasing the stud press and removing the spark plug insulator assembly from the protective housing.

As used herein, a “seal material” refers to a material used to prevent leakage and internally connect a terminal stud and a center electrode. In the context of the present disclosure, a seal material can be electrically conductive. It can be made or constructed of compressed glass/metal powder, or a multi-layer braze. The seal material used in the present disclosure can be softened or liquified at a sufficient temperature (e.g., in some cases, approximately 900° C., 850-950° C., or 800-900° C.).

In some embodiments, the seal material is conductive glass.

In some embodiments, the insertion inserted in step (d) of the process above is a terminal stud or a center electrode.

The present disclosure also includes an automated system for fabricating and/or assembling a spark plug insulator assembly according to certain embodiments. Such a system comprises: (a) at least one apparatus configured to prepare a suppressor seal of a spark plug insulator assembly using induction heat; (b) one or more auxiliary units, the one or more auxiliary units being configured to perform the following operations: (i) filling the spark plug insulator with a seal material; (ii) placing a spark plug insulator on the apparatus; (iii) inserting an insertion into the spark plug insulator; (iv) applying and releasing the stud press; and (v) removing the spark plug insulator assembly from the apparatus; and (c) one or more computerized control units, the one or more computerized control units being configured to control operation of the at least one apparatus and the one or more auxiliary units. In some embodiments, the automated system can be configured to process and/or output 10-120 spark plug insulator assemblies per minute.

In the context of the present disclosure, an “auxiliary unit” can refer to one or a plurality of peripheral devices that work and/or coordinate with the apparatus disclosed herein, to implement the desired processes as those disclosed herein, including, e.g., feeding raw materials, operating parts of the apparatus, removing finished products, etc. An auxiliary unit, as used herein, may generally include any means, device, and/or apparatus that is unmanned and/or computer programed.

In some embodiments, the one or more auxiliary units comprise one or more automated robotic arms configured to perform at least one of the operations identified in (i)-(v) of the automated system above.

The following discussion provides examples to further illustrate the present disclosure. These examples are illustrative only and are not intended to limit the scope of the disclosure in any way.

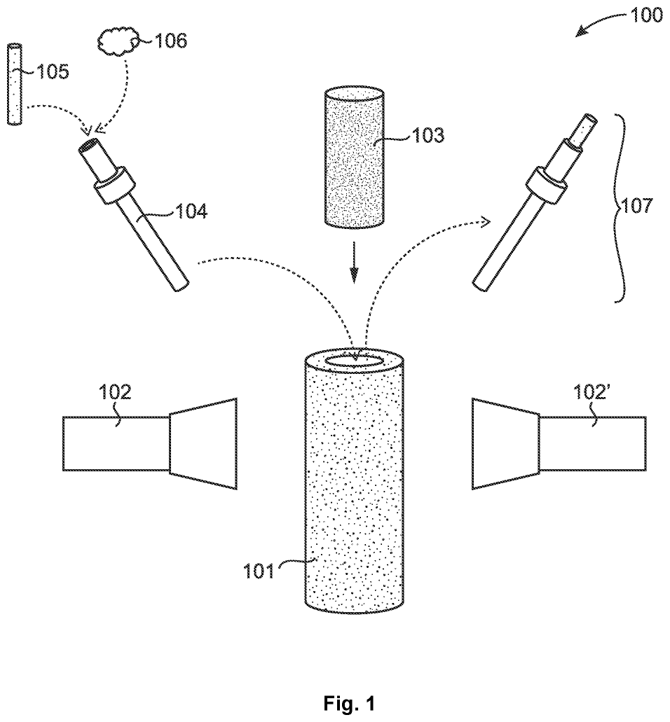

An existing apparatus 100 for implementing a natural gas pressure seal process is shown in FIG. 1. In this process, two oppositely facing Meker style laboratory burners 102 and 102′ are used to apply heat to a spark plug insulator 104 that is placed inside a protective housing 101. Filled with a resistor seal material 106, the spark plug insulator 104 along with the protective housing 101 are heated for approximately 3 minutes until the temperature inside the spark insulator 104 is approximately 900° C. The filled insulator is then removed from the burner area while the burners 102 and 102′ remain lit. An insertion 105 (e.g., a center electrode or a terminal stud) is inserted into one end of the filled sparck plug insulaor to construct a spark plug insulator assembly 107. Thereafter, an operator applies pressure to the spark plug stud 103 to compress the insertion 105 and the softened seal material 106 and they are held in that position for approximately one additional minute. The finished product (i.e., the spark plug insulator assembly 106) is then removed from the protective housing 101.

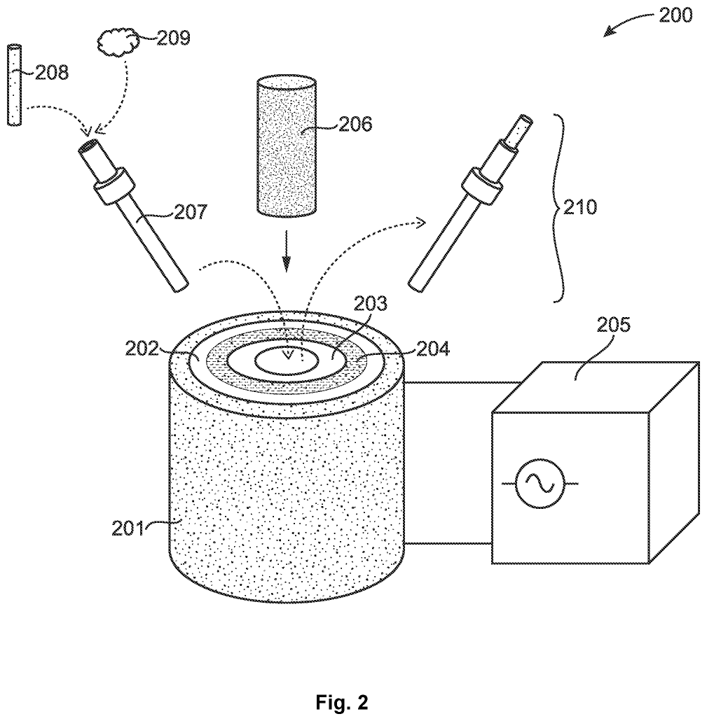

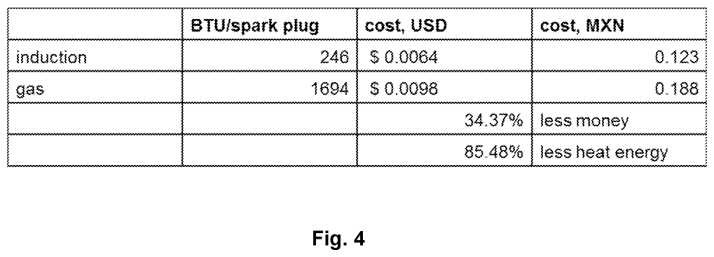

A new apparatus 200 according to an illustrative embodiment of the present disclosure is shown in FIG. 2. In this new apparatus, high frequency (e.g., within the range of 1-200 kilohertz) alternating electrical current is applied to create heat, which is input into a spark plug insulator 207 with radiation of infrared light instead of convection of the flames as in the existing apparatus 100. This generates or results in less heated air needing to be exhausted, which is the mechanism for reducing energy consumption by over 80% (see FIG. 4). The apparatus 200 includes a protective housing 203 that accommodates a spark plug insulator 207, a crucible 204 surrounding the protective housing 203, an induction heating element 201 (e.g., an induction heating coil) placed nearby the outer surface of the crucible 204, an induction power supply 205 connected to the induction heating element 201, and a stud press 206. The apparatus 200 may further include an alumina spacer 202 in between the crucible 204 and the induction heating element 201 to constrain the relative location of these three objects and maintain consistant heating performance over time.

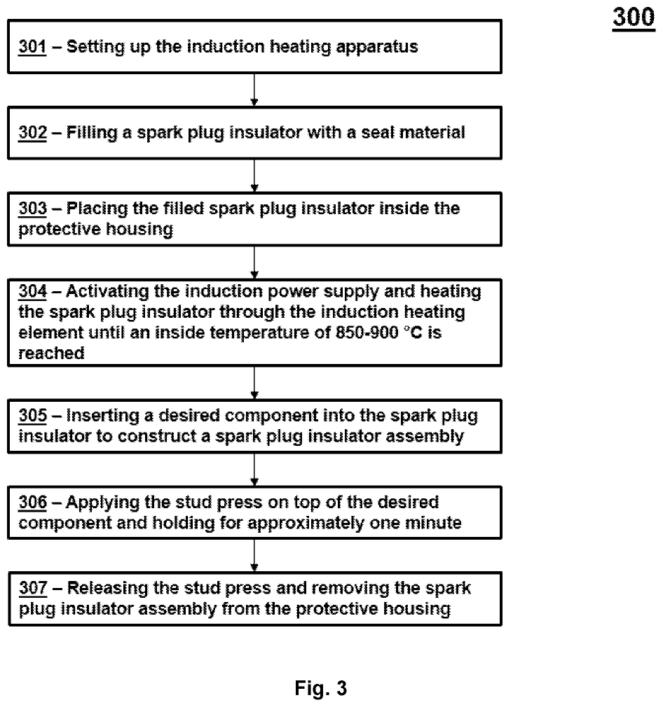

A process 300 for assembling a spark plug insulator assembly using the new apparatus disclosed herein is further illustrated in FIG. 3, in accordance with certain embodiments of the present disclosure. To start the process, an apparatus according to the present disclosure, for example, the apparatus 200 is set up (step 301). A spark plug insulator 207 is filled with a seal material 209, e.g., conductive glass, and then placed inside the protective housing 203 (steps 302, 303). The protective housing can be selected to accommodate different insulator models in different orientations. The induction power supply 205 is then activated by turning it on to generate heat through the induction heating element 201 (step 304). When the temperature inside the spark plug insulator 207 reaches around 850-900° C., the induction power supply 205 can be turned off, and an insertion 208 (e.g., a center electrode or a terminal stud) can be inserted into one end of the spark plug insulator 207 to construct a spark plug insulator assembly 210 (step 305). To create a gas-tight suppressor seal, the stud press 206 is applied on top of the insertion and is held at its position for a sufficient period of time (in some embodiments, approximately one minute) (step 306). Finally, the stud press 206 is released and the finished product (i.e., the spark plug insulator assembly 209) is removed from the protective housing 203 (step 307). In certain embodiments, this process 300 can be implemented by an automated system that may introduce or include other auxiliary units such as, e.g., a set of automated robotic arms, to scale up the production and further improve efficiency. Additionally, or alternatively, this process 300 can be performed, at least in part, with the assistance of a human operator.

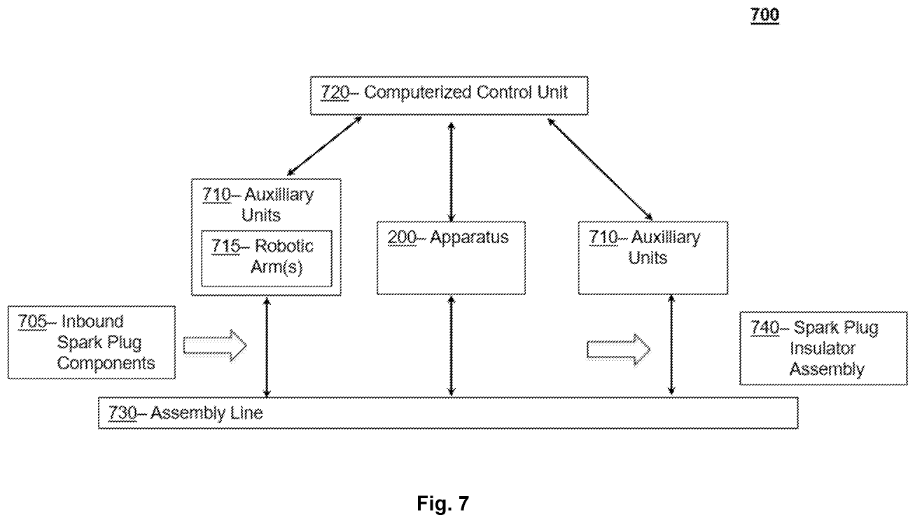

FIG. 7 is an exemplary automated system 700 for fabricating and/or assembling a spark plug insulator assembly with a suppressor seal according to certain embodiments. As shown therein, inbound spark plug components 705 (including, e.g., a spark plug insulator, a center electrode or a terminal stud, a seal material, etc.) are received by an assembly line 730. One or more auxiliary units 710 (e.g., one or more automated robotic arms 715) controlled by a computerized control unit 720 then feeds the inbound spark plug components 705 into an apparatus using induction heat 200 in a pre-programed order and timing to obtain a spark plug insulator assembly with a suppressor seal. Once assembled, one or more auxiliary units 710 (could be the same as or different from those above), as commanded by the computerized control unit 720, retrieve the finished assembly from the apparatus 200 and place it on a converyor of the assembly line 730 for transport.

The exemplary processes described in the present disclosure demonstrated benefits over the existing processes in various aspects, including but not limited to, energy saving, cost saving, and improved performance of the finished products. Specifically, the following experiments were conducted with a prototype of the induction heating apparatus constructed in the laboratory. The test results were compared with those of the currently employed gas heating device under the same work settings (as explained below in details) to verify and document the benfits.

On the existing gas burner setup, the metal burners have a 0.080″ fuel flow orifice with a needle valve throttle and operate at 26 oz/in² (1.625 psi) of fuel pressure. These parameters are not defined in their manufacturing specification of the burner so a calorimeter measurement was collected. Best results were collected when one of the two burners was applied 2″ from to the bottom of a large thin walled stainless steel vessel with 10 pounds of water in it. Rates of change in water temperature were measured to reach 3 degrees in as little as 15 seconds using a large thermocouple sensor and aggressive stirring. This heating rate suggests that at least 8500 BTU (British thermal units) are being released by each burner and 17000 BTU total. It is worth noting that this is likely an underestimate because heat was escaping around the water filled vessel. That said, this establishes a lower bound of energy input.

The amount of energy for the induction system used in the experiments was collected with a clamp meter reading the electrical current going into the machine, and then converted to BTU for a comparison to gas.

For comparison, prices for energy were used based on average 2019 costs of 1.712 MXN/KWH and 105 MXN/GJ. An approximate 86% decrease on energy consumption was found, which would cut over one-third of the cost (see FIG. 4 for details).

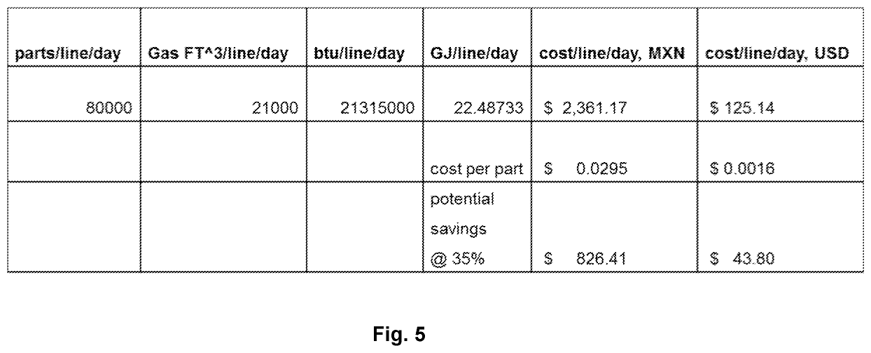

Given the production line in a factory is more efficient than the prototype system in a laboratory, efficiency was increased by scaling up the prototype process to the continuous process. The estimated savings on costs can be found in FIG. 5 (note: FT\hat{ }3: cubic feet; GJ: gigajoule). As shown therein, in a factory located in Mexico, the reduction on gas and energy consumption can potentially save the costs by 35%.

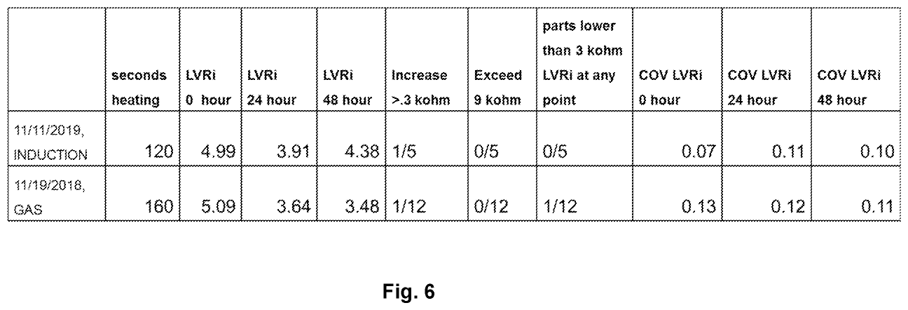

The test data also showed that the induction heating process described in this disclosure had at least equivalent performance in the electrical resistance of the suppressor seal compared to the natural gas process (demonstrated in FIG. 6 by LVRi data at various test times; note: LVRi: seal resistance at 5 vdc, HVRi: seal resistance at 4500 vdc and; COV: covariance). From the test results, the induction heating process was faster (second column), also had less scrap (count of parts in 8^{th} column) and less variation (last three columns) in the resistance values.

Although illustrative embodiments of the present disclosure have been described herein, it should be understood that the disclosure is not limited to those described, and that various other changes or modifications may be made by one skilled in the art. For example, it should be understood that various omissions and substitutions and changes in the form and details of the systems and methods described and illustrated may be made by those skilled in the art. Amongst other things, the steps in the methods may be carried out in different orders in many cases where such may be appropriate. Further variations, modifications, and implementations may occur to those of ordinary skill in the art without departing from the scope or spirit of the disclosure.

What is claimed is:

1. An apparatus for preparing a suppressor seal of a spark plug insulator assembly, comprising:
(a) a protective housing for the spark plug insulator;
(b) a crucible surrounding the housing;
(c) an induction heating element placed nearby the outer surface of the crucible;
(d) an induction power supply connected to the induction heating element; and
(e) a stud press.

2. The apparatus of claim 1, wherein the protective housing can be selected to accommodate different spark plug insulators or the same spark plug insulator in different orientations.

3. The apparatus of claim 1, wherein the protective housing is thermally conductive.

4. The apparatus of claim 1, wherein the crucible is placed in close proximity of the protective housing to efficiently transfer heat.

5. The apparatus of claim 1, wherein the crucible is electrically conductive.

6. The apparatus of claim 1, wherein the crucible is made of metal or ceramic.

7. The apparatus of claim 1, wherein the crucible is made of a material selected from the group consisting of alumina, zircornia, magnesia, quartz, graphite, corundum, pyrolytic boron nitride (PBN), platinum, tungsten, molybdenum, tantalum, nickel, zirconium, silicon carbide, and vitreous carbon.

8. The apparatus of claim 1, wherein the crucible is made of molybdenum disilicide (MoSi₂).

9. The apparatus of claim 1, wherein the induction heating element is an induction heating coil winding around the crucible.

10. The apparatus of claim 1, wherein the induction heating element can radiantly heat the spark plug insulator up to an inside temperature of 850-900° C.

11. The apparatus of claim 1, further comprising a spacer situated in between the crucible and the induction heating element.

12. The apparatus of claim 11, wherein the spacer is made of aluminum oxide (Al₂O₃).

13. The apparatus of claim 1, wherein the stud press can compress and hold an insertion within the spark plug insulator.

14. The apparatus of claim 13, wherein the insertion is a terminal stud or a center electrode.

15. The apparatus of claim 1, wherein the stud press is automated.

16. A process for fabricating and/or assembling a spark plug insulator assembly, comprising the steps of:
(a) filling a spark plug insulator with a seal material;
(b) placing the spark plug insulator inside a protective housing;
(c) activating an induction power supply and heating the spark plug insulator until an inside temperature of 850-900° C. is reached;
(d) inserting an insertion into the spark plug insulator to construct a spark plug insulator assembly;
(e) applying a stud press on top of the insertion and holding for approximately one minute; and
(f) releasing the stud press and removing the spark plug insulator assembly from the protective housing.

17. The process of claim 16, wherein the seal material is conductive glass.

18. The process of claim 16, wherein the insertion inserted in step (d) is a terminal stud or a center electrode.

19. An automated system for fabricating and/or assembling a spark plug insulator assembly, comprising:
(a) at least one apparatus configured to prepare a suppressor seal of a spark plug insulator assembly using induction heat;
(b) one or more auxiliary units, the one or more auxiliary units being configured to perform the following operations:
(i) filling the spark plug insulator with a seal material;
(ii) placing a spark plug insulator on the apparatus;
(iii) inserting an insertion into the spark plug insulator;
(iv) applying and releasing a stud press; and
(v) removing the spark plug insulator assembly from the apparatus; and
(c) one or more computerized control units, the one or more computerized control units being configured to control operation of the at least one apparatus and the one or more auxiliary units.

20. The automated system of claim 19, wherein the one or more auxiliary units comprise one or more automated robotic arms configured to perform at least one of the operations identified in (i)-(v).
